(19) United States
(12) Patent Application Publication
(10) Pub. No.: US 2015/0376432 A1
(43) Pub. Date: Dec. 31, 2015

(54) INK SET

(71) Applicant: OCÉ-TECHNOLOGIES B.V., Venlo (NL)

(72) Inventors: Karel P.D. VAN ZEEVENTER, Grashoek (NL); Johannes F. J. VAN GAGELDONK, Venlo (NL); Ronald GROOTHUIJSE, Sevenum (NL); Anton BRUIL, Venlo (NL); Vincent G.R. LIMA, Roermond (NL); Robert E.J. VAN DEN BERCKEN, Horst (NL)

(73) Assignee: OCÉ-TECHNOLOGIES B.V., Venlo (NL)

(21) Appl. No.: 14/847,701

(22) Filed: Sep. 8, 2015

Related U.S. Application Data
(63) Continuation of application No. PCT/EP2014/054465, filed on Mar. 7, 2014.

(30) Foreign Application Priority Data
Mar. 8, 2013 (EP) 13158438.5

(51) Int. Cl. C09D 11/40; C08K 5/053; C08K 5/5419

(52) U.S. Cl. CPC C09D 11/40; C08K 5/5419; C08K 5/053

(57) ABSTRACT

The present invention relates to an ink set comprising a first ink composition and a second ink composition, the ink compositions comprising a silicone surfactant, the total concentration of silicone surfactants in the ink compositions being different in order to control bleeding of the ink compositions into each other.

This application is a Continuation of PCT International Application No. PCT/EP2014/054465 filed on Mar. 7, 2014, which claims priority under 35 U.S.C. §119(a) to patent application Ser. No. 13/158,438.5 filed in Europe on Mar. 8, 2013, all of which are hereby expressly incorporated by reference into the present application.

### FIELD OF THE INVENTION

The present invention generally pertains to an ink set suitable for use in inkjet printing, said ink set comprising at least two differently colored inks. The inks comprised in the ink set are designed such that inter color bleeding may be controlled in such a way that it is not/less visible in the prints, at least where it concerns the darkest and lightest color. The darkest color is the one with the lowest L* value (CIELAB color system), and the lightest color the one with the highest L* value.

### BACKGROUND ART

Bleeding is defined as an invasion of a first ink having a first color into a second ink having a second color, once the first ink and the second ink have been deposited on a print medium, as evidenced by a ragged interface between a first (partial) image of the first ink and a second (partial) image of the second ink.

The occurrence of bleeding is particularly problematic when an ink having a darker color invades an ink having a lighter color because it is all the more visible. The surface tension of an ink is seen as a parameter of the ink that may be responsible for bleeding. The surface tension as used in the prior art is usually construed as the surface tension between an ink and air. In U.S. Pat. No. 7,988,277 B2, it is disclosed that when two inks of different colors meet each other on the print medium, the ink with the lower surface tension will bleed into the ink with the higher surface tension. Since the surface tension of an ink is normally time dependent, it decreases from the relatively high dynamic surface tension (also termed bulk surface tension) to a lower static surface tension, and because of the fact that the different ink colors are not jetted at the same time, bleeding is usually from the first into a later jetted color. This is why, in the prior art, it is described to jet the ink having the darkest color as the latter, which gives a better result regarding bleeding, as is also disclosed in U.S. Pat. No. 7,988,277 B2.

Another option described in the prior art is adding surfactants to change the dynamic surface tension so that the darkest color has the highest dynamic surface tension, as is disclosed in U.S. Pat. No. 8,343,268 B2.

It is therefore a disadvantage of the ink sets known from the prior art that in order to properly control bleeding, the different color inks must be printed in a certain (fixed) order.

It is therefore an object of the present invention to provide an ink set that prevents or at least mitigates the above stated disadvantage. The ink set of the present invention comprises at least two colored inks that have a controlled bleeding behavior regardless of the order of printing the inks.

### SUMMARY OF THE INVENTION

This object may be at least partially achieved by providing an ink set comprising a first ink having a first color and a second ink having a second color different from the first color, the first ink comprising a first surfactant that is active on an interface between the first ink and the second ink and/or on an interface between the first ink and the print medium.

In the present embodiment the ink set comprises two inks wherein only one of the two needs to be adapted according the findings in this invention.

The first ink of the ink set according to the present invention bleeds into the second ink of the ink set. Therefore, in an embodiment, the first ink is of a lighter color than the second ink, In this embodiment, the bleeding of the lighter color ink into the darker color ink is less visible if not at all.

In an embodiment, the ink set comprises a third ink, wherein the third ink is of the darkest color in the ink set, the second ink comprising a second surfactant that is active on an interface between the first ink and the second ink and/or on an interface between the second ink and the third ink and/or on an interface between the second ink and the print medium, the second surfactant being the same or different than the first surfactant and wherein the activity of the first surfactant in the first ink is larger than the activity of the second surfactant in the second ink.

The term “activity” in the context of the present invention is to be construed as a relative term that indicates which ink bleeds into which ink. The ink comprising the surfactant with the highest activity may bleed into all other inks. The ink comprising the surfactant with the lowest activity allows all other inks to bleed into it. The activity may depend on the type of surfactant that is used in an ink and on the concentration of the surfactant in that ink. If different types of surfactant are used in different inks, the activity has to be determined by experimentation, e.g. by bleeding experiments.

If all inks comprise the same type of surfactant, the concentration of the surfactant in the different inks determines the activity.

In an embodiment, the first surfactant and the second surfactant are the same and the concentration of the first surfactant in the first ink is higher than the concentration of the second surfactant in the second ink. The higher concentration of the first surfactant in the first ink compared to the second surfactant (which is the same as the first surfactant) in the second ink provides the first surfactant in the first ink with a higher activity than the activity of the second surfactant in the second ink.

In an embodiment, the third ink comprises a third surfactant that is active on an interface between the third ink and the first ink and/or on an interface between the second ink and the third ink and/or on an interface between the third ink and the print medium, the third surfactant being the same or different than the first surfactant and/or the second surfactant and wherein the activity of the second surfactant in the second ink is larger than the activity of the third surfactant in the third ink

In an embodiment, the first surfactant, the second surfactant and the third surfactant are the same and the concentration of the first surfactant in the first ink is higher than the concentration of the second surfactant in the second ink, the concentration of the second surfactant in the second ink is higher than the concentration of the third surfactant in the third ink. The higher concentration of the second surfactant in the second ink compared to the third surfactant (which is the same as the second and the first surfactant) in the third ink provides the second surfactant in the second ink with a higher activity than the activity of the third surfactant in the third ink.

If the first surfactant and/or the second surfactant and/or the third surfactant are not the same, the concentrations of the respective surfactants in the respective inks is to be adapted such that the activity of the first surfactant in the first ink is larger than the activity of the second surfactant in the second ink, which in turn is larger than the activity of the third surfactant in the third ink.

In an embodiment, the surfactants in the different inks of the ink set may be the same or different from each other. However, if the surfactants in the different inks are the same, the concentration of these surfactants in the darkest ink (i.e., having the lowest L* according to the CIELAB color system) will be the lowest and the concentration of these surfactants in the lightest color (i.e., having the highest L* according to the CIELAB color system) will be the highest. Inks having intermediate colors, which in the context of the present invention is to be construed as having a color darker than the lightest ink and lighter than the darkest ink may have a surfactant in a concentration between the concentration in the darkest ink and the concentration in the lightest ink.

In an embodiment, the ink set comprises a fourth ink, the fourth ink, having a fourth surfactant that is active on an interface between the first ink and the fourth ink and/or on an interface between the second ink and the fourth ink and/or on an interface between the third ink and the fourth ink and/or on an interface between the fourth ink and the print medium, the fourth surfactant being the same or different than the first surfactant and/or the second surfactant and/or the third surfactant and wherein the activity of the fourth surfactant in the fourth ink is larger than the activity of the third surfactant in the third ink and smaller than the activity of the first surfactant in the first ink.

In an embodiment, the activity of the second surfactant in the second ink and the activity of the fourth surfactant in the fourth ink are substantially equal to each other.

This embodiment is of particular relevance when the ink set comprises two or more inks of intermediate color as defined above and the inks of intermediate color have similar L* values according to the CIELAB color system.

The first ink in the ink set according to this embodiment may bleed into all other inks in the ink set. The third ink in the ink set according to this embodiment allows all other inks to bleed into it.

In an embodiment, the first ink is of the lightest color (having the highest L* value), the third ink is of the darkest color (having the lowest L* value), the second and the fourth ink are of intermediate color as defined above (both having L* values between the L* value of the first ink and the L* value of the third ink).

In an embodiment, the first ink is a yellow colored ink.

In an embodiment, the second ink is a magenta colored ink.

In an embodiment, the third ink is a black colored ink.

In an embodiment, the fourth ink is a cyan colored ink.

In an embodiment, the first surfactant comprises a mixture of surfactants.

In an embodiment, the second surfactant comprises a mixture of surfactants.

In an embodiment, the third surfactant comprises a mixture of surfactants.

In an embodiment, the fourth surfactant comprises a mixture of surfactants.

In an embodiment, the difference between the concentration of the first surfactant in the first ink and the concentration of the second surfactant in the second ink, wherein the first surfactant and the second surfactant are the same is at least 0.02 wt %, preferably between 0.03 wt % and 1.5 wt %, more preferably between 0.04 wt % and 1.0 wt %, even more preferably between 0.05 wt % and 0.5 wt %.

In an embodiment, the difference between the concentration of the first surfactant in the first ink and the concentration of the fourth surfactant in the fourth ink, wherein the first surfactant and the fourth surfactant are the same is at least 0.02 wt %, preferably between 0.03 wt % and 1.5 wt %, more preferably between 0.04 wt % and 1.0 wt %, even more preferably between 0.05 wt % and 0.5 wt %.

In an embodiment, the difference between the concentration of the third surfactant in the third ink and the concentration of the second surfactant in the second ink, wherein the third surfactant and the second surfactant are the same is at least 0.02 wt %, preferably between 0.03 wt % and 1.5 wt %, more preferably between 0.04 wt % and 1.0 wt %, even more preferably between 0.05 wt % and 0.5 wt %.

In an embodiment, the difference between the concentration of the third surfactant in the third ink and the concentration of the fourth surfactant in the fourth ink, wherein the third surfactant and the fourth surfactant are the same is at least 0.02 wt %, preferably between 0.03 wt % and 1.5 wt %, more preferably between 0.04 wt % and 1.0 wt %, even more preferably between 0.05 wt % and 0.5 wt %.

Depending on the total mixture of surfactants, all inks in an ink set according to the present invention may have substantially similar dynamic and static surface tensions, on the interface between each ink and air. So measuring the dynamic and static surface tension with e.g. a bubble tension meter, the results might be, but are not necessarily, the same. The contact angle for the different inks from the ink set with different media might also be the same. The severity of bleeding of inks comprised in an ink set according to the present invention is therefore not dependent of the color sequence, i.e. the order in which different colored inks are printed on a print medium.

The darkest color in the ink set according to the present invention may be changed so that all other colors bleed into the darkest color and the lightest color may be changed so that it may bleed into all the other colors. Inventors have surprisingly found that the present invention works for at least all aqueous ink systems. However, the present invention is not limited to aqueous inks.

The inventors have surprisingly found that it is not, solely, the surface tension between ink and air that determines the amount of bleeding. Changing the amount of surfactant in the ink without changing the surface tension between ink and air may (also) determine the level of bleeding. Without wanting to be bound to any theory, it is believed that these surfactants may, not exclusively, work on the ink-ink interface. The higher the concentration difference of a surfactant in an ink compared to the other inks, the more that ink may bleed into the other inks. So realizing the highest concentration for the lightest color and the lowest concentration for the darkest color, and the other colors in between, may lead to the situation where all colors may bleed into the darkest color and the lightest color may bleed into all other colors. This effect may be so dominant that it may not be necessary to put the darkest color at the end. It can be put at every color position. The same holds for the lightest color, which does not necessarily have to be in the first position.

Therefore, the present invention pertains to:

1. An ink set, comprising:

a first ink composition and

a second ink composition,

wherein the first and second ink compositions comprise a silicone surfactant, and

wherein the total concentration of silicone surfactants in the first and second ink compositions are different in order to control bleeding of the first and second ink compositions into each other.

2. The ink set according to 1, wherein the first ink composition has a lightness L₁* and the second ink composition has a lightness L₂*, the lightness being defined in accordance with the CIELAB color system, wherein L₂*<L₁*, wherein the first and second ink compositions comprise a silicone surfactant, wherein the total weight fraction of silicone surfactant in the first ink composition is larger than the total weight fraction of silicone surfactant in the second ink composition.
3. The ink set according to 2, wherein the ratio of the total weight fraction of silicone surfactant in the second ink composition and the total weight fraction of the silicone surfactant in the first ink composition is in a range of between 0 and 0.95, preferably between 0.5 and 0.9, more preferably between 0.7 and 0.8.
4. The ink set according to any one of 2 to 3, wherein the ink set comprises a third ink composition having a lightness L₃*, wherein L₃*<L₂*<L₁*, wherein the third ink composition comprises a silicone surfactant, wherein the total weight fraction of silicone surfactant in the second ink composition is larger than the total weight fraction of silicone surfactant in the third ink composition.
5. The ink set according to any one of 2 to 4, wherein the third ink composition has the lowest lightness value of the ink set.
6. The ink set according to 5, wherein the third ink composition is a black ink composition.
7. The ink set according to any one of 4 to 6, wherein the first ink composition has the highest lightness value of the ink set.
8. The ink set according to 7, wherein the first ink composition is a yellow ink composition.
9. The ink set according to any one of 2 to 8, wherein the second ink composition is a cyan and/or magenta ink composition.
10. The ink set according to any one of 1 to 9, wherein the silicone surfactant is selected from the group consisting of siloxane surfactants, in particular ethoxylated siloxane surfactants.
11. The ink set according to 10, wherein the silicone surfactant has a structure according to Formula 2:

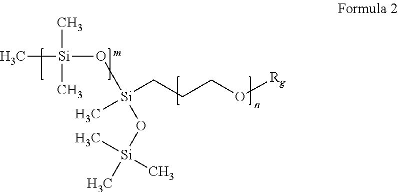

wherein m is an integer ranging from 1-25, preferably from 1-20, more preferably from 2-15 and wherein n is an integer ranging from 1-10, preferably from 1-8, more preferably from 1-5, and wherein Rg is an endgroup which may be selected from —H and alkyl (e.g. methyl).
12. The ink set according to any one of 1 to 11, wherein the silicone surfactant in each ink composition is present in an amount of between 0 and 1.5 wt % relative to the total ink compositions.
13. The ink set according to any one of 1 to 12, wherein each ink composition further comprises an acetylene glycol surfactant, preferably an ethoxylated acetylene surfactant in an amount of between 0.5 and 2 wt % relative to the total ink composition.
14. The ink set according to 13, wherein each ink composition contains an equal amount of acetylene glycol surfactant.
15. The ink set according to any one of 1 to 14 comprising a black, cyan, magenta and yellow pigmented aqueous ink composition, wherein each composition comprises an ethoxylated acetylene surfactant in an equal amount of between 0.5 and 2 wt % relative to the total ink composition and wherein the ink compositions further comprise an ethoxylated siloxane surfactant in an amount of between 0 and 1 wt %, wherein the amount of siloxane surfactant in the yellow ink composition is the highest compared to the other ink compositions and wherein the amount of siloxane surfactant in the black ink is the lowest compared to the other ink compositions.

### BRIEF DESCRIPTION OF THE DRAWINGS

The present invention will become more fully understood from the detailed description given herein below and accompanying schematical drawings which are given by way of illustration only and are not limitative of the invention, and wherein:

FIGS. 1A and 1B show schematic representations of interfaces in a print medium—ink—air system.

FIG. 2 shows a photograph of (a part of) a test file, which is used to determine the bleeding level of an ink set.

FIG. 3A shows a photograph of (a part of) a test file, which shows bleeding of Cyan (C0) ink into Magenta (M0) ink, when M0 is printed first, for an ink set according to the prior art.

FIG. 3B shows a photograph of (a part of) a test file, which shows bleeding of Cyan (C0) ink into Magenta (M+) ink, when M+ is printed first, for an ink set according to the present invention, wherein the M+ ink comprises a higher surfactant concentration than the C0 ink.

FIG. 3C shows a photograph of (a part of) a test file, which shows bleeding of Cyan (C0) ink into Magenta (M−) ink, when M− is printed first, for an ink set according to the present invention, wherein the M− ink comprises a lower surfactant concentration than the C0 ink.

FIG. 4 shows a graphical representation of the measured level of bleeding for the situations shown in FIGS. 3A, 3B and 3C.

FIG. 5A shows a photograph of (a part of) a test file, which shows bleeding of Magenta (M0) ink into Cyan (C0) ink, when M0 is printed first, for an ink set according to the prior art.

FIG. 5B shows a photograph of (a part of) a test file, which shows bleeding of Magenta (M+) ink into Cyan (C0) ink, when M+ is printed first, wherein the M+ ink comprises a higher surfactant concentration than the C0 ink.

FIG. 5C shows a photograph of (a part of) a test file, which shows bleeding of Magenta (M−) ink into Cyan (C0) ink, when M− is printed first, wherein the M− ink comprises a lower surfactant concentration than the C0 ink.

FIG. 6 shows a graphical representation of the measured level of bleeding for the situations shown in FIGS. 5A, 5B and 5C.

FIG. 7 shows a photograph of (a part of) a test file, which shows bleeding of Magenta (M+) ink into Cyan (C0) ink, when C0 is printed first, wherein the M+ ink comprises a higher surfactant concentration than the C0 ink.

FIG. 8 shows a graphical representation of the measured level of bleeding for a Cyan (C0) line in a Magenta (M+) area wherein C0 is printed first and vice versa; and a M+ line in a C0 area wherein C0 is printed first and vice versa, wherein the M+ ink comprises a higher surfactant concentration than the C0 ink.

FIG. 9 shows a photograph of (a part of) a test file, which shows bleeding levels for a Full Color ink set according to the prior art.

FIG. 10 shows a photograph of (a part of) a test file, which shows bleeding levels for a Full Color ink set according to the present invention.

FIG. 11 shows a graphical representation of the measured bleeding level for the situation of FIGS. 9 and 10.

FIG. 12 shows a photograph of (a part of) a test file, which shows bleeding levels for a MYK ink set according to the present invention.

FIG. 13 shows a photograph of (a part of) a test file, which shows bleeding levels for a MYK ink set according to the present invention.

FIG. 14 shows a graphical representation of the measured bleeding level for the situations of FIGS. 9, 12 and 13.

### DETAILED DESCRIPTION

### Ink Composition

An ink comprised in the ink set according to the present invention may comprise a colorant, a solvent, a cosolvent, a resin, a surfactant and optionally other additives. The components of the inks will be described in detail in the next sections.

### Colorant

The colorant may be a dye, a pigment, a combination of dyes, a combination of pigments or a combination of dyes and pigments. The colorants may be suitably selected.

### Solvent

Water is cited as an environmentally friendly and hence desirable solvent. In the present invention, the content of water to the whole ink is preferably from 20 weight % to 80 weight %. It is more preferable that the content of water is from 30 weight % to 75 weight %, even more preferable from 40 weight % to 70 weight %.

### Cosolvent

As a solvent of the ink, for the purposes of improving the ejection property of the ink or adjusting the ink physical properties, the ink preferably contains a water soluble organic solvent in addition to water. As long as the effect of the present invention is not damaged, there is no restriction in particular in the type of the water soluble organic solvent.

Examples of the water-soluble organic solvent include polyhydric alcohols, polyhydric alcohol alkyl ethers, polyhydric alcohol aryl ethers, nitrogen-containing heterocyclic compounds, amides, amines, ammonium compounds, sulfur-containing compounds, propylene carbonate, and ethylene carbonate.

Examples of the solvent include: glycerin (also termed glycerol), propylene glycol, dipropylene glycol, tripropylene glycol, tetrapropylene glycol, polypropylene glycol, ethylene glycol, diethylene glycol, triethylene glycol, tetraethylene glycol, polyethylene glycols preferably having a molecular weight of between 200 gram/mol and 1000 gram/mol (e.g. PEG 200, PEG 400, PEG 600, PEG 800, PEG 1000), glycerol ethoxylate, petaerythritol ethoxylate, polyethylene glycol (di)methylethers preferably having a molecular weight of between 200 gram/mol and 1000 gram/mol, tri-methylol-propane, diglycerol (diglycerin), trimethylglycine (betaine), N-methylmorpholine N-oxide, decaglyserol, 1,4-butanediol, 1,3-butanediol, 1,2,6-hexanetriol, 2-pyrrolidinone, dimethylimidazolidinone, ethylene glycol mono-butyl ether, diethylene glycol monomethyl ether, diethylene glycol monoethyl ether, diethylene glycol mono-propyl ether, diethylene glycol mono-butyl ether, triethylene glycol monomethyl ether, triethylene glycol monoethyl ether, triethylene glycol mono-propyl ether, triethylene glycol mono-butyl ether, tetraethylene glycol monomethyl ether, tetraethylene glycol monoethyl ether, propylene glycol mono-butyl ether, dipropylene glycol monomethyl ether, dipropylene glycol monoethyl ether, dipropylene glycol monopropyl ether, diethylene glycol monobutyl ether, tripropylene glycol monomethyl ether, tripropylene glycol monoethyl ether, tripropylene glycol monopropyl ether, tripropylene glycol monobutyl ether, tetrapropylene glycol monomethyl ether, diethylene glycol diethyl ether, diethylene glycol dibutyl ether, triethylene glycol diethyl ether, triethylene glycol dibutyl ether, dipropylene glycol dibutyl ether, tri propylene glycol dibutyl ether, 3-methyl 2,4-pentanediol, diethylene-glycol-monoethyl ether acetate, 1,2-hexanediol, 1,2-pentanediol and 1,2-butanediol.

The total amount of the water-soluble organic solvent contained in the ink composition is not particularly limited. It is, however, preferably 0 weight % to 75 weight %, and more preferably 10 weight % to 70 weight %, and even more preferably 15 weight % to 60 weight % with respect to the total ink composition. When the amount of the water-soluble organic solvent is more than 80 weight %, the drying times of the ink compositions are too long. When the amount is less than 10 weight %, water in the ink compositions may evaporate more quickly, which may significantly reduce the stability of the ink composition.

### Resin

The inkjet ink according to the present invention may contain a resin, in particular a water-dispersible resin (i.e., a latex resin) in view of the pigment fixability to recording media. As the water-dispersible resin, a water-dispersible resin excellent in film formability (image formability) and having high water repellency, high waterfastness, and high weatherability is useful in recording images having high waterfastness and high image density (high color developing ability).

Examples of the water-dispersible resin include synthetic resins and natural polymer compounds.

Examples of the synthetic resins include polyester resins, polyurethane resins, polyepoxy resins, polyamide resins, polyether resins, poly(meth)acrylic resins, acryl-silicone resins, fluorine-based resins, polyolefin resins, polystyrene-based resins, polybutadiene-based resins, polyvinyl acetate-based resins, polyvinyl alcohol-based resins, polyvinyl ester-based resins, polyvinyl chloride-based resins, polyacrylic acid-based resins, unsaturated carboxylic acid-based resins and copolymers such as styrene-acrylate copolymer resins and styrene-butadiene copolymer resins.

Examples of the natural polymer compounds include celluloses, rosins, and natural rubbers.

Examples of commercially available water-dispersible resin emulsions include: Joncryl 537 and 7640 (styrene-acrylic resin emulsion, made by Johnson Polymer Co., Ltd.), Microgel E-1002 and E-5002 (styrene-acrylic resin emulsion, made by Nippon Paint Co., Ltd.), Voncoat 4001 (acrylic resin emulsion, made by Dainippon Ink and Chemicals Co., Ltd.), Voncoat 5454 (styrene-acrylic resin emulsion, made by Dainippon Ink and Chemicals Co., Ltd.), SAE-1014 (styrene-acrylic resin emulsion, made by Zeon Japan Co., Ltd.), Jurymer ET-410 (acrylic resin emulsion, made by Nihon Junyaku Co., Ltd.), Aron HD-5 and A-104 (acrylic resin emulsion, made by Toa Gosei Co., Ltd.), Saibinol SK-200 (acrylic resin emulsion, made by Saiden Chemical Industry Co., Ltd.), and Zaikthene L (acrylic resin emulsion, made by Sumitomo Seika Chemicals Co., Ltd.), acrylic copolymer emulsions of DSM Neoresins, e.g. the NeoCryl product line, in particular acrylic styrene copolymer emulsions NeoCryl A-662, NeoCryl A-1131, NeoCryl A-2091, NeoCryl A-550, NeoCryl BT-101, NeoCryl SR-270, NeoCryl XK-52, NeoCryl XK-39, NeoCryl A-1044, NeoCryl A-1049, NeoCryl A-1110, NeoCryl A-1120, NeoCryl A-1127, NeoCryl A-2092, NeoCryl A-2099, NeoCryl A-308, NeoCryl A-45, NeoCryl A-615, NeoCryl BT-24, NeoCryl BT-26, NeoCryl BT-36, NeoCryl XK-15, NeoCryl X-151, NeoCryl XK-232, NeoCryl XK-234, NeoCryl XK-237, NeoCryl XK-238-NeoCryl XK-86, NeoCryl XK-90 and NeoCryl XK-95 However, the water-dispersible resin emulsion is not limited to these examples.

The content of the water-dispersible resin added in the ink of the present invention is preferably from 1-40 weight % based on the total weight of the ink, and it is more preferably from 1.5-30 weight %, and it is still more preferably from 2-25 weight %.

Even more preferably, the amount of the water-dispersible resin contained in the inkjet ink, as a solid content, is 2.5 weight % to 15 weight %, and more preferably 3 weight % to 7 weight %, relative to the total ink composition.

In an embodiment, the ink composition according to the present invention comprises two or more water-dispersible resins selected from the above cited synthetic resins, synthetic copolymer resins and natural polymer compounds in admixture with each other.

### Surfactants

It is preferable that the ink of the present invention contains a surfactant in order to improve an ink ejection property and/or the wettability of the surface of a recording medium, and the image density and color saturation of the image formed and reducing white spots therein. To improve the spreading of the ink on the surface of recording medium and to reduce puddling, it is preferable to adjust the dynamic surface tension (measured at 10 Hz) of the ink composition to 35 mN/m or lower, preferably to 34 nN/m or lower, more preferably to 33 mN/m or lower, even more preferably to 32 mN/m or lower by the surfactant. The static surface tension of the ink composition is preferably below 30 mN/m (measured at 0.1 Hz).

Examples of surfactants are not specifically limited. The following can be cited.

Examples of the surfactant include nonionic surfactants, cationic surfactants, anionic surfactants, amphoteric surfactants, in particular betaine surfactants, silicone surfactants, and fluorochemical surfactants. Particularly, at least one selected from acetylene surfactants, silicone surfactants and fluorochemical surfactants capable of reducing the surface tension to 30 mN/m or lower is preferably used.

Examples of a cationic surfactant include: aliphatic amine salts, aliphatic quarternary ammonium salts, benzalkonium salts, benzethonium chloride, pyridinium salts, imidazolinium salts.

Examples of an anionic surfactant include: polyoxyethylene alkylether acetic acid salts, dodecylbenzene sulfonic acid salts, lauric acid salts, and salts of polyoxyethylene alkylether sulfate, an aliphatic acid soap, an N-acyl-N-methyl glycin salt, an N-acyl-N-methyl-f3-alanine salt, an N-acylglutamate, an acylated peptide, an alkylsulfonic acid salt, an alkylbezenesulfonic acid salt, an alkylnaphthalenesulfonic acid salt, a dialkylsulfo succinate (e.g. sodium dioctyl sulfosuccinate (DSS); alternative names: docusate sodium, Aerosol OT and AOT), alkylsulfo acetate, α-olefin sulfonate, N-acyl-methyl taurine, a sulfonated oil, a higher alcohol sulfate salt, a secondary higher alcohol sulfate salt, an alkyl ether sulfate, a secondary higher alcohol ethoxysulfate, a polyoxyethylene alkylphenyl ether sulfate, a monoglysulfate, an aliphatic acid alkylolamido sulfate salt, an alkyl ether phosphate salt and an alkyl phosphate salt.

Examples of an amphoteric surfactant include: a carboxybetaine type, a sulfobetaine type, an aminocarboxylate salt and an imidazolium betaine.

Examples of a nonionic surfactant include: polyoxyethylene alkylether, polyoxypropylene polyoxyethylene alkylether, a polyoxyethylene secondary alcohol ether, a polyoxyethylene alkylphenyl ether, a polyoxyethylene sterol ether, a polyoxyethylenelanolin derivative polyoxyethylene polyoxypropylene alkyl ether, polyoxyethylene alkylester, a polyoxyethyleneglycerine aliphatic acid ester, a polyoxyethylene castor oil, a hydrogenated castor oil, a polyoxyethylene sorbitol aliphatic acid ester, a polyethylene glycols aliphatic acid ester, an aliphatic acid monoglyceride, a polyglycerine aliphatic acid ester, a sorbitan aliphatic acid ester, polyoxyethylene sorbitan aliphatic ester, a propylene glycol aliphatic acid ester, a cane sugar aliphatic acid ester, an aliphatic acid alkanol amide, polyoxyethylene alkylamide, a polyoxyethylene aliphatic acid amide, a polyoxyethylene alkylamine, an alkylamine oxide, an acetyleneglycol, an ethoxylated acetylene glycol, and acetylene alcohol.

It is preferable that a part of these surfactants is furthermore substituted with a fluorine atom or a silicon atom from a viewpoint of reducing the surface tension.

As the fluorochemical surfactant, a surfactant having 2 to 16 fluorine-substituted carbon atoms is preferred, and a surfactant having 4 to 16 fluorine-substituted carbon atoms is more preferred. When the number of fluorine-substituted carbon atoms is less than 2, the effect peculiar to a fluorochemical surfactant may not be obtained. When it is more than 16, degradation in storage stability etc. may arise.

Examples of the fluorochemical surfactants include nonionic fluorochemical surfactants, anionic fluorochemical surfactants, and amphoteric fluorochemical surfactants. Examples of the nonionic fluorochemical surfactants include perfluoroalkyl phosphoric acid ester compounds, perfluoroalkyl ethylene oxide adducts, and polyoxyalkylene ether polymer compounds having perfluoroalkyl ether groups as side chains. Among these, polyoxyalkylene ether polymer compounds having perfluoroalkyl ether groups as side chains are preferable because they are low in foaming property.

As the fluorochemical surfactants, commercially available products may be used. Examples of the commercially available products include SURFLON S-HI, S-112, S-113, S-121, S-131, S-132, S-141 and S-145 (all of which are produced by Asahi Glass Co., Ltd.), FLUORAD FC-93, FC-95, FC-98, FC-129, FC-135, FC-170C, FC-430 and FC-431 (all of which are produced by Sumitomo 3M Limited), MEGAFAC F-470, F-1405 and F-474 (all of which are produced by Dainippon Ink Chemical Industries Co., Ltd.), ZONYL TBS, FSP, FSA, FSN-100, FSN, FSO-100, FSO, FS-300 and UR (all of which are produced by E. I. du Pont de Nemours and Company), FT-110, FT-250, FT-251, FT-400S, FT-150 and FT-400SW (all of which are produced by Neos Company Limited), and POLYFOX PF-136A, PF-156A, PF-151N, PF-154, and PF-159 (all of which are produced by OMNOVA Solutions Inc.). Among these, ZONYL FS-300 (produced by E. I. du Pont de Nemours and Company), FT-110, FT-250, FT-251, FT-400S, FT-150, FT-400SW (produced by Neos Company Limited), and POLYFOX PF-151N (produced by OMNOVA Solutions Inc.) are preferable in that they are excellent in print quality, particularly in color developing ability and in dye-leveling property.

The silicone surfactant is not particularly limited and may be suitably selected in accordance with the intended use.

Examples of the silicone surfactant include side-chain-modified polydimethylsiloxane, both-ends-modified polydimethylsiloxane, one-end-modified polydimethylsiloxane, and side-chain/both-ends-modified polydimethylsiloxane. Polyether-modified silicone surfactants having, as a modified group, a polyoxyethylene group or a polyoxyethylene polyoxypropylene group are particularly preferable because they exhibit excellent physical properties as water-based surfactants.

The silicone surfactant may be suitably synthesized or commercial products may be used. The commercial product is readily available from BYK Chemie GmbH, Shin-Etsu Chemical Co., Ltd., TORAY Dow Corning Silicone Co., Ltd., Nihon Emulsion Co., Ltd., Kyoeisha Chemical Co., Ltd., or the like.

The polyether-modified silicone surfactant is not particularly limited and may be suitably selected in accordance with the intended use. Examples thereof include a compound in which a polyalkylene oxide structure represented by Formula 1 is induced in the Si portion side chain of dimethyl polysiloxane.

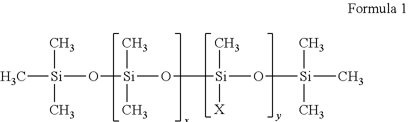

wherein X=—R(C₂H₄O)ₐ(C₃H₆O)_{b}R′

In Formula 1, x, y, a and b are each an integer; R represents an alkyl group, and R′ represents an alkylene group.

In an embodiment, the silicone surfactant, is an ethoxylated siloxane surfactant, having a general formula as shown in Formula 2.

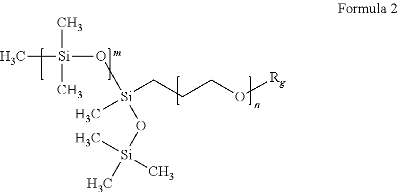

wherein m is an integer ranging from 1-25, preferably from 1-20, more preferably from 2-15 and wherein n is an integer ranging from 1-10, preferably from 1-8, more preferably from 1-5. Rg is an endgroup which may be selected from —H and alkyl (e.g., methyl).

In an embodiment, the number average molar weight (Mₙ) of the ethoxylated siloxane used as a surfactant in an ink composition according to the present invention lies in a range of between 300 gr/mol and 1000 gr/mol, preferably between 350 gr/mol and 950 gr/mol, more preferably between 450 gr/mol and 850 gr/mol.

In an embodiment, the weight average molar weight (M_{w}) of the ethoxylated siloxane used as a surfactant in an ink composition according to the present invention lies in a range of between 600 gr/mol and 1600 gr/mol, preferably between 700 gr/mol and 1500 gr/mol, more preferably between 800 gr/mol and 1400 gr/mol

In an embodiment, the polydispersity factor (D=M_{w}/Mₙ) of the ethoxylated siloxane used as a surfactant in an ink composition according to the present invention lies in a range of between 1 and 2, preferably between 1 and 1.95, more preferably between 1.3 and 1.9.

In an embodiment, the ethoxylated siloxane surfactant is selected from the group consisting of BYK 348, BYK 349, Silwet L-77 and Tegowet 240. Structural properties of these surfactants are shown in Table A with reference to Formula 2.

TABLE A
structural properties of siloxane surfactants
satisfying Formula 4

| | BYK 348 | BYK 349 | Silwet L-77 | Tegowet 240 |
|---|---|---|---|---|
| R_{g} (endgroup) | —H | —H | —CH₃ | —H |
| Mₙ¹⁾ (gr/mol) | 800 | 700 | 700 | 500 |
| M_{w}¹⁾ (gr/mol) | 1400 | 1250 | 850 | 800 |
| D¹⁾ (—) | 1.8 | 1.9 | 1.3 | 1.5 |
| average n²⁾ | 12.6 | 8.3 | 11.6 | 8.3 |
| n (range)³⁾ | 2-12 | 2-11 | 2-7 | 2-15 |
| n (mostly present)³⁾ | 6 | 5 | 5 | 3-4 |
| m³⁾ | 1-2 | 1-4 | 1 | 1 |

¹⁾determined with SEC (method see experimental part)
²⁾determined with NMR (method see experimental part)
³⁾determined with LC-MS (method see experimental part)

As the polyether-modified silicone surfactant, commercial products may be used.

Examples of the commercial products include KF-618, KF-642 and KF-643 (produced by Shin-Etsu Chemical Co., Ltd.); EMALEX-SS-5602 and SS-1906EX (produced by Nihon Emulsion Co., Ltd.); FZ-2105, FZ-2118, FZ-2154, FZ-2161, FZ-2162, FZ-2163 and FZ-2164 (produced by TORAY Dow Corning Silicone Co., Ltd.); and BYK-33, BYK 331, BYK 341, BYK 348, BYK 349, BYK 3455, BYK-387 (produced by BYK Chemie GmbH); Tegowet 240, Tegowet 245, Tegowet 250, Tegowet 260 (produced by Evonik); and Silwet L-77 (produced by Sabic).

In an embodiment, the first surfactant and/or the second surfactant and/or the third surfactant and/or the fourth surfactant are independently of one another selected from the group of polyether-modified silicone surfactants as represented by Formula 1.

In an embodiment, the first surfactant and/or the second surfactant and/or the third surfactant and/or the fourth surfactant are independently of one another selected from the group consisting of the following commercially available surfactants: KF-618, KF-642 and KF-643 (produced by Shin-Etsu Chemical Co., Ltd.); EMALEX-SS-5602 and SS-1906EX (produced by Nihon Emulsion Co., Ltd.); FZ-2105, FZ-2118, FZ-2154, FZ-2161, FZ-2162, FZ-2163 and FZ-2164 (produced by TORAY Dow Corning Silicone Co., Ltd.); and BYK-33, BYK 331, BYK 341, BYK 348, BYK 349, BYK 3455, BYK-387 (produced by BYK Chemie GmbH); Tegowet 240, Tegowet 245, Tegowet 250, Tegowet 260 (produced by Evonik); and Silwet L-77 (produced by Sabic).

All surfactants mentioned in this section may be used solely, or they may be used in combination of the plural.

The total amount of the surfactant contained in the inkjet ink is preferably 0.01 weight % to 3.0 weight %, and more preferably 0.5 weight % to 2 weight %, with respect to the total ink composition. When the amount of the surfactant is less than 0.01 weight %, the effect of adding the surfactant may be substantially reduced or even insignificant. When it is more than 3.0 weight %, the permeability to recording media may be higher than necessary, possibly causing a degradation of image density and occurrence of ink-strikethrough.

### Bleeding Mechanism

Without wanting to be bound to any theory, it is believed that for an ink set according to the present invention comprising at least two inks, bleeding may be controlled by using a surfactant or a mixture of surfactants in the inks of the ink set according to the present invention

Surfactants are surface active agents. A surface active agent may be active at an interface between two phases, e.g. ink—air, ink—ink or ink—print medium.

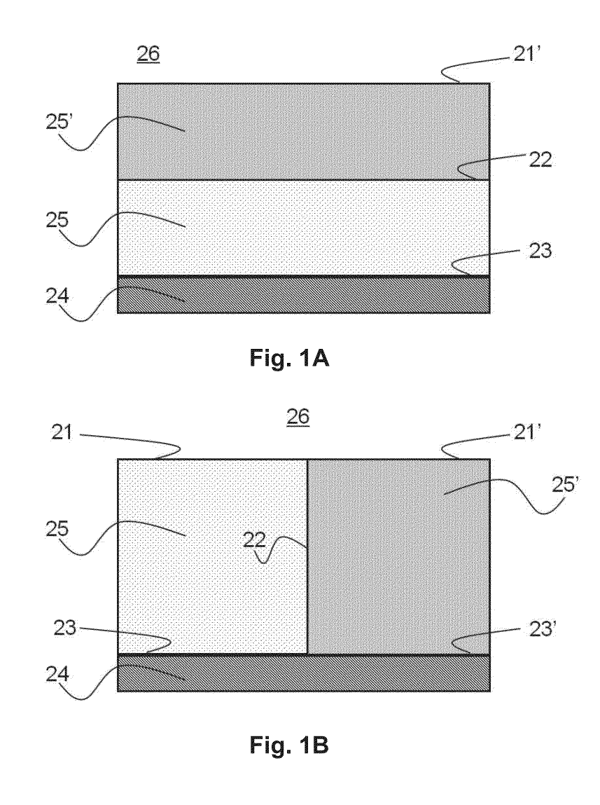

In FIGS. 1A and 1B, the different interfaces for surfactants to work are shown, in case two inks 25 and 25′ are combined on a surface of a print medium 24. FIG. 1A shows the situation wherein ink 25 is printed on top of a surface of print medium 24 and ink 25′ is printed on top of ink 25. FIG. 1B shows the situation wherein inks 25 and 25′ are both printed on top of a surface of the print medium 24. 26 represents air.

Generally, the surface tension of an ink is characterized by measuring the surface tension of the ink—air interfaces 21 and 21′ of the respective inks 25 and 25′. In the prior art bleeding between inks 25 and 25′ is correlated to the surface tensions at the ink-air interfaces 21 and 21′

In the present invention surfactants are used that are not designed to work on the ink—air interfaces 21 and/or 21′, but have (primarily but not exclusive) their function on the ink-ink interface 22 and/or the ink—print media interface 23 and 23′. Adding such a surfactant may lower the surface tension at that specific interface (i.e. interface 22, and/or 23, and/or 23′) and not or hardly the surface tension at the ink-air interface 21′ and as the case may be ink-air interface 21. Lowering the amount of such a surfactant may do the opposite. Given the recipes of the whole ink set, it is not necessary that these surfactants are the same or of the same type. Bleeding may be from the inks with the higher activity of surfactants (or when the same type of surfactant is used to adapt the inks in the ink set that need adaptation according to the present invention, the concentration of the surfactant) into the inks with the lower activity (or in the case described above, the concentration) of the surfactants.

So by giving the highest activity (concentration) of surfactants to the ink with the lightest color, this color may bleed into all the other colors. Giving the lowest activity (concentration) of surfactants to the ink with the darkest color, all other colors may bleed into the darkest color.

Although bleeding is not eliminated, it is not/less visible in the prints. For this invention, it also holds that it is (nearly) independent of the color sequence.

### EXPERIMENTS

### Description of the Measurement Techniques

### Bleeding

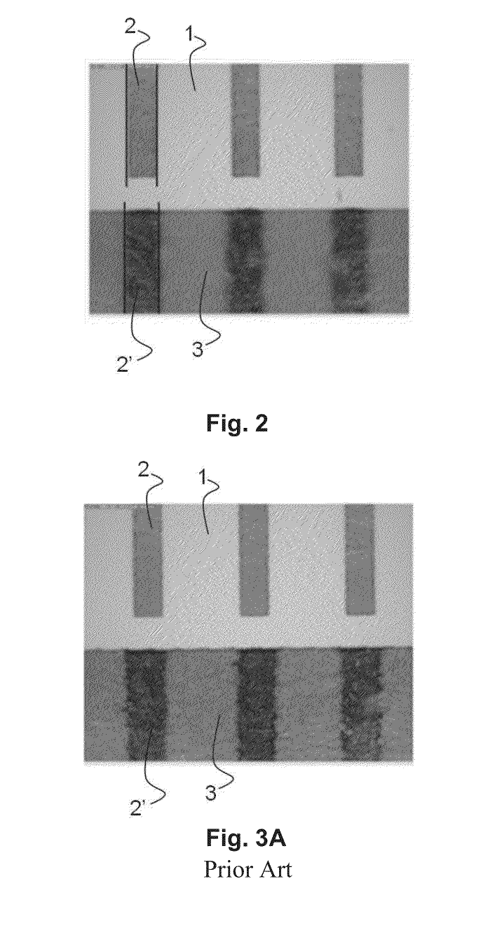

Bleeding is measured as the difference in line width between a first 17 pixel (i.e., a line having a width corresponding to 17 pixels) line 2 with no color as background (i.e., background is print medium 1) and a second 17 pixel line 2′ with a background 3 of another color, see FIG. 2. The image is processed with software of ImageXpert, where the line width is determined. To be independent of registration while printing, the line is printed over the background and not in the background, so the coverage is locally 200% instead of 100%. The bleeding level is the difference in line width between the line without background and a same line with another color as background

Prints are all made with the Kyocera KJ4-Series 600 dpi print head, using dotsize 3 (i.e., approximately 12 pl. droplets).

### Surface Tension

The surface tension is measured using a Sita bubble pressure tensiometer, model SITA online t60, according to the (maximum) bubble pressure method. The surface tension of the liquids to be tested (e.g., inks according to the present invention) is measured at 30° C. unless otherwise indicated. Unless stated otherwise, the static surface tension is determined at a bubble frequency of 0.2 s′, which corresponds to a bubble life time of 5000 ms. Unless stated otherwise, the dynamic surface tension is at 20 s⁻¹, which corresponds to a bubble life time of 50 ms.

The surface tension measured according to this method is representative of the surface tension of the ink—air interface as shown in FIGS. 1A and 1B.

### Materials

### Print Media

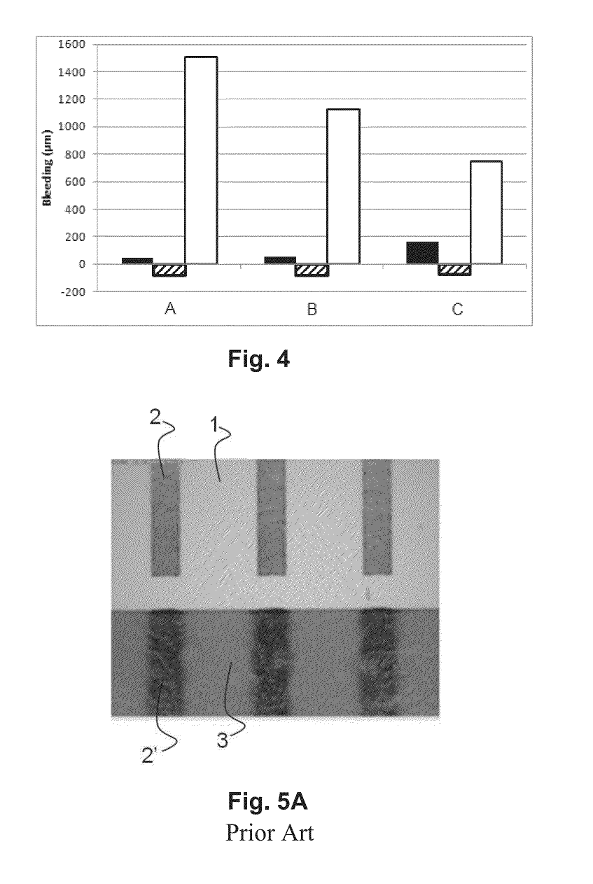

The media used in the experiments are given in Table 1. The capital letters in the first column are adhered to in the representation of the results of the experiments, for example as shown in FIGS. 4, 6, 8 and 11. In the second column, the supplier and the type of print medium is stated.

TABLE 1
Print media used in the experiments.
Media List

| | |
|---|---|
| A | Appleton - Utopia Book, 67 gsm |
| B | UPM - Finesse Gloss, 115 gsm |
| C | UPM - Finesse Matt, 115 gsm |

### Inks

The inks as shown in Tables 2 and 3 were prepared by mixing the ingredients such that the amounts of the respective components in the inks were as indicated in Tables 2, 3A and 3B. Table 2 shows the ink compositions as used in Examples 1-3. Table 3A shows that an ink set according to the present invention may be represented by a combination of inks K2, C, M, Y2. (Example 4). An ink set not according to the present invention may be represented by a combination of inks K1, C, M and Y1 (Comparative Example A). Table 3B shows that two ink sets according to the present invention may be represented by a combination of inks K3, M (Table 3A) and Y3 (Example 5) and by a combination of K3, M′ and Y4 (Example 6).

TABLE 2
The composition of the standard Cyan and Magenta inks (C0 and
M0 respectively) and the Magenta inks with extra surfactant (M+)
and less surfactant (M−). All amounts are in weight % (wt %)
relative to the total ink composition

| Material | Supplier | C0 | M0 | M+ | M− |
|---|---|---|---|---|---|
| Pigment | Fuji | 2 | 5 | 5 | 5 |
| Latex A662 | DSM | 9 | 7 | 7 | 7 |
| 1,2 hexanediol | Sigma-Aldrich | 4 | 4 | 4 | 4 |
| glycerol | Sigma-Aldrich | 7.5 | 7.5 | 7.5 | 7.5 |
| Pentaerythritol | Sigma-Aldrich | 16 | 16 | 16 | 16 |
| ethoxylate | | | | | |
| (3/4 EO/OH) | | | | | |
| Dynol 607 | Air Products | 0.8 | 0.8 | 0.8 | 0.8 |
| Tegowet 240 | Evonik Tego | 0.3 | 0.3 | 0.3 | 0 |
| | Chemie | | | | |
| Byk 348 | Byk | 0 | 0 | 0.3 | 0 |
| Water (demi | | to 100 | to 100 | to 100 | to 100 |
| or UHQ) | | | | | |

TABLE 3A
The composition of ink compositions. K1, K2 = black, C = Cyan, M = Magenta,
Y1, Y2 = Yellow. All amounts are in weight % (wt %) relative to the total ink composition.

| Material | Supplier | K1 | K2 | C | M | Y1 | Y2 |
|---|---|---|---|---|---|---|---|
| Latex A662 | DSM | 9 | 9 | 12 | 9 | 11 | 11 |
| Pigment | Fuji | 4 | 4 | 2 | 5 | 3 | 3 |
| 2,3-butanediol | Sigma-Aldrich | 8 | 8 | 8 | 8 | 8 | 8 |
| Pentaerythritol | Sigma-Aldrich | 7.5 | 7.5 | 7.5 | 7.5 | 7.5 | 7.5 |
| ethoxylate (3/4 EO/OH) | | | | | | | |
| Dianhydro-D-glucitol | Sigma-Aldrich | 5 | 5 | 5 | 5 | 5 | 5 |
| (2-Hydroxypropyl)-β- | Sigma-Aldrich | 2.5 | 2.5 | 2.5 | 2.5 | 2.5 | 2.5 |
| cyclodextrine | | | | | | | |
| Vantex T | Taminco | 0.25 | 0.25 | 0.25 | 0.25 | 0.25 | 0.25 |
| Dynol 607 | Air Products | 0.8 | 0.8 | 0.8 | 0.8 | 0.8 | 0.8 |
| Tegowet 240 | Evonik Tego | 0.4 | 0.0 | 0.4 | 0.4 | 0.4 | 0.4 |
| | Chemie | | | | | | |
| Byk 348 | Byk | 0.0 | 0.0 | 0.0 | 0.0 | 0.0 | 0.3 |
| Water (demi or UHQ) | | to 100 | to 100 | to 100 | to 100 | to 100 | to 100 |
| Static surface tension | Bubble lifetime | 25.6 | 29.6 | 25.6 | 25.9 | 25.9 | 27.2 |
| (mN/m) | of 6000 ms¹⁾ | | | | | | |
| Dynamic surface tension | Bubble lifetime | 33.1 | 37.2 | 33.1 | 33.2 | 33.9 | 32.5 |
| (mN/m) | of 50 ms | | | | | | |

¹⁾The static surface tensions of the example inks at a bubble lifetime of 6000 ms are similar to the static surface at a bubble lifetime of 5000 ms.

TABLE 3B
The composition of ink compositions K3, K4 = black, M′ = magenta, Y3 and Y4 =
yellow. All amounts are in weight % (wt %) relative to the total ink composition.

| Material | Supplier | K3 | K4 | M′ | Y3 | Y4 |
|---|---|---|---|---|---|---|
| Latex A662 | DSM | 9 | 9 | 9 | 11 | 11 |
| Pigment | Fuji | 4 | 4 | 5 | 3 | 3 |
| 2,3-butanediol | Sigma-Aldrich | 8 | 8 | 8 | 8 | 8 |
| Pentaerythritol | Sigma-Aldrich | 7.5 | 7.5 | 7.5 | 7.5 | 7.5 |
| ethoxylate (3/4 EO/OH) | | | | | | |
| Dianhydro-D-glucitol | Sigma-Aldrich | 5 | 5 | 5 | 5 | 5 |
| (2-Hydroxypropyl)-β- | Sigma-Aldrich | 2.5 | 2.5 | 2.5 | 2.5 | 2.5 |
| cyclodextrine | | | | | | |
| Vantex T | Taminco | 0.25 | 0.25 | 0.25 | 0.25 | 0.25 |
| Dynol 607 | Air Products | 0.8 | 0.8 | 0.8 | 0.8 | 0.8 |
| Tegowet 240 | Evonik Tego | 0.3 | 0.0 | 0.0 | 0.5 | 0.0 |
| | Chemie | | | | | |
| Byk 348 | Byk | 0.0 | 0.3 | 0.4 | 0.0 | 0.5 |
| Water (demi or UHQ) | | to 100 | to 100 | to 100 | to 100 | to 100 |
| Static surface tension | Bubble lifetime | 25.8 | 27.5 | 27.2 | 25.1 | 27.1 |
| (mN/m) | of 6000 ms¹⁾ | | | | | |
| Dynamic surface tension | Bubble lifetime | 32.3 | 34.8 | 34.6 | 32.3 | 34.8 |
| (mN/m) | of 50 ms | | | | | |

¹⁾The static surface tensions of the example inks at a bubble lifetime of 6000 ms are similar to the static surface at a bubble lifetime of 5000 ms.

### Example 1

In example 1, a Cyan (C0 from Table 2) and Magenta (M0 or M+ or M− from Table 2) ink combination was used because they are comparable in respect to lightness (L*), so it is possible to see both the bleeding of Cyan in Magenta and of Magenta in Cyan. The Cyan ink composition is left unchanged and is represented by C0.

The Magenta ink composition is varied with surfactant concentration to see the effect on bleeding (M0, M+ and M−). In this first example, Magenta is printed first. Thus, the background 3 is printed first and is magenta colored. Afterwards, cyan colored lines 2 and 2′ are printed.

The measured surface tension at the ink-air interface (see 21 and 21′ in FIG. 1) for a bubble life-time of 50 ms (bubble frequency of 20 s⁻¹) is respectively 33.0, 33.4, 32.9 and 35.0 mN/m for the C ink, the M ink, the M ink with extra surfactant and the M ink with less surfactant. For a bubble lifetime of 5000 ms (bubble frequency of 0.2 s⁻¹), these values are respectively 26.9, 26.8, 26.4 and 28.2 mN/m.

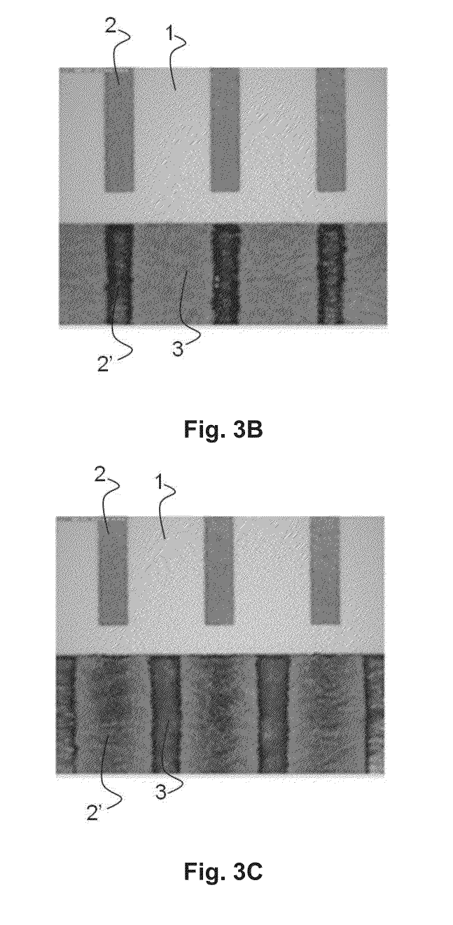

In the photographs shown in FIGS. 3A-3C, the level of bleeding is visual for a Cyan line in a Magenta area, where FIG. 3A shows the combination with the Magenta ink with the same amount of surfactants as the C0 ink, which is the M0 ink from Table 2; FIG. 3B shows the combination with the Magenta ink comprising extra surfactant (M+); and FIG. 3C shows the combination with the Magenta ink comprising less surfactant (M−).

In FIG. 4, the measured bleeding level is shown for these situations (i.e., as shown in FIGS. 3A-3C as described above). The capital letters on the x-axis of the graph in FIG. 4 represent the media types given in Table 1. On the y-axis, the difference between line widths printed and determined as indicated above is shown in micrometers.

For the combination of Cyan and Magenta inks having the same amount of surfactant (i.e., C0 and M0), bleeding is visible and measured to be 50 μm-200 μm, depending on the print media, as represented by the black bars in FIG. 4. From FIG. 3B, it can be concluded that by adding surfactant in the Magenta ink, and hence obtaining M+ ink, may suppress the level of bleeding of C0 into M+. In fact, it can be seen by comparing FIGS. 3A and 3B and it is also measured that the line width decreases (see shaded bars in FIG. 4), so there is bleeding from M+ into C0 instead of the other way around (bleeding level around −100 μm). From FIG. 3C, it can be concluded that leaving out surfactant in the Magenta ink (and thus obtaining M− ink) may increase the amount of bleeding from C0 into M− tremendously. This can be seen by comparing the photographs of FIG. 3C and FIG. 3A and is also measured (approx. 1500 μm for medium A, approx. 1100 μm for medium B and approx. 700 μm for medium C) and represented by the white bars in FIG. 4.

### Example 2

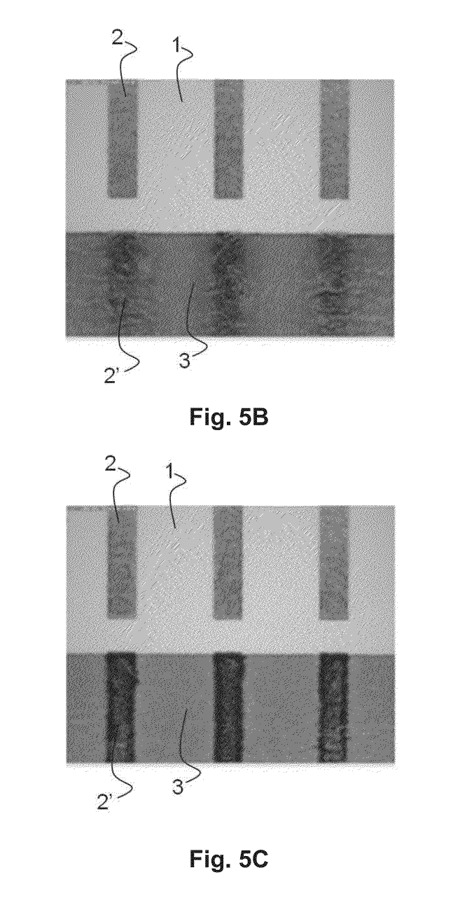

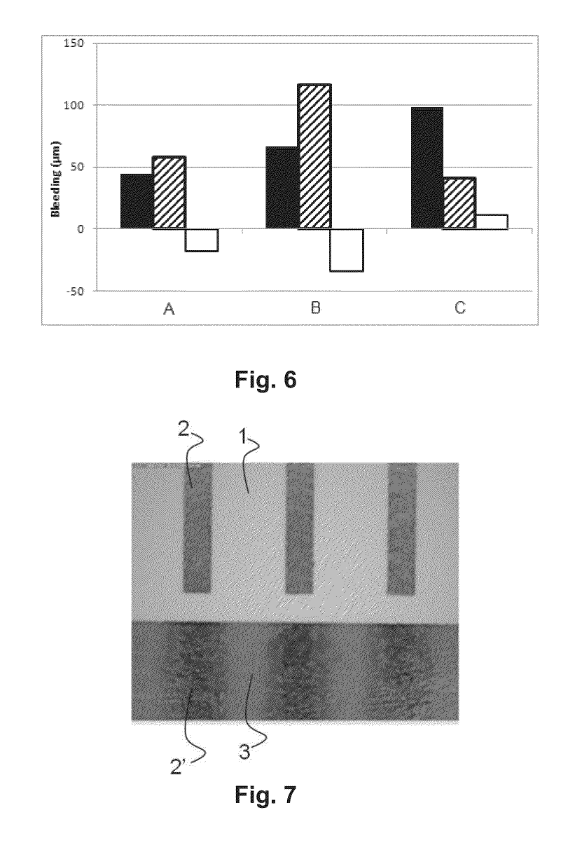

In FIG. 5 and FIG. 6, the same kind of data is shown, but now for the bleeding of a Magenta line in a Cyan area. Thus, the background 3 is printed first and is Cyan colored. Afterwards, Magenta colored lines 2 and 2′ are printed.

From FIG. 5A, it is clear that now the M0 line bleeds into the C0 area. The bleeding level of M0 into C0 is represented by the black bars in FIG. 6. From FIG. 5B, it can be seen that adding extra surfactant to the M0 ink (and thus obtaining the M+ ink as shown in Table 2) may increase the level of bleeding. This is not so clear from the measurements as shown in FIG. 6, which may be due to the fact that, for this situation, the visual edge of the line is further away than the edge determined with the software. The level of bleeding between M+ and C0 is represented by the shaded bars in FIG. 6. From FIG. 5C, it can be deduced that decreasing the amount of surfactant in Magenta (and thus obtaining the M− ink as shown in Table 2) may decrease the bleeding of Magenta in Cyan. In fact, now one can see bleeding of C0 into M−. The level of bleeding between M+ and C0 in this example is represented by the white bars in FIG. 6. The capital letters on the x-axis of the graph in FIG. 6 represent the media types given in Table 1. On the y-axis, the difference between line widths printed and determined as indicated above is shown in micrometers.

So from the above (Examples 1 and 2), it becomes clear that adding surfactant may increase the bleeding of that ink into the other ink. Decreasing the amount of surfactant may increase the bleeding of another ink into this ink.

In the ink set as used in Examples 1 and 2, Dynol 607, which is an ethoxylated acetylene based surfactant obtained from Air Products, was used as a surfactant, which is primarily active at the ink-air interface. Both Tegowet240 and Byk348, both ethoxylated siloxane based surfactants obtained from Evonik and Byk, respectively, were used as surfactants to work (primarily) on the ink-ink interfaces and/or ink/media interface.

Varying the latter two shows that bleeding can be steered with the concentration of the surfactant as long as the surfactant does not (primarily) work on the surface tension of the ink-air interface.

### Example 3

In the present example, C0 and M+ inks as shown in Table 2 were used. The same print samples have been made, but now Cyan is printed before Magenta. Thus, the background 3 is printed first and is cyan colored. Afterwards, magenta colored lines 2 and 2′ are printed.

In FIG. 7, the bleeding of M+ in C0 is visible. In fact, it is comparable with the photograph in FIG. 5B.

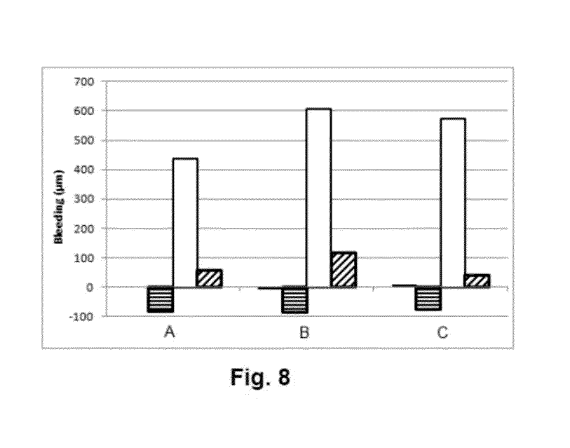

In FIG. 8, the measured values are shown for the ink combination C0 and Magenta with extra surfactant (M+), both with C0 printed first (black colored bars and white colored bars in FIG. 8) and with M+ printed first (shaded bars in FIG. 8), and both for the bleeding of a C0 line in an M+ area (black colored bars and horizontally shaded bars in FIG. 8) and for the bleeding of an M+ line in a C0 area (white colored bars and diagonally shaded bars in FIG. 8). As already mentioned, the measured values for the M+ line in a C0 area are smaller than visually interpreted. Taking this into account, it is visible that M+ does bleed into C0 and that the color sequence does not influence this situation.

The capital letters on the x-axis of the graph in FIG. 8 represent the media types given in Table 1. On the y-axis, the difference between line widths printed and determined as indicated above is shown in micrometers.

### Comparative Example A

### Bleeding Performance of an Ink Set not According to the Present Invention

Inks C, M, Y1 and K1 from Table 3 were combined to form an ink set that does not satisfy the criteria of the present invention. In this ink set, all inks contained the same amount of the same surfactants. The used color sequence to print the inks was YMCK.

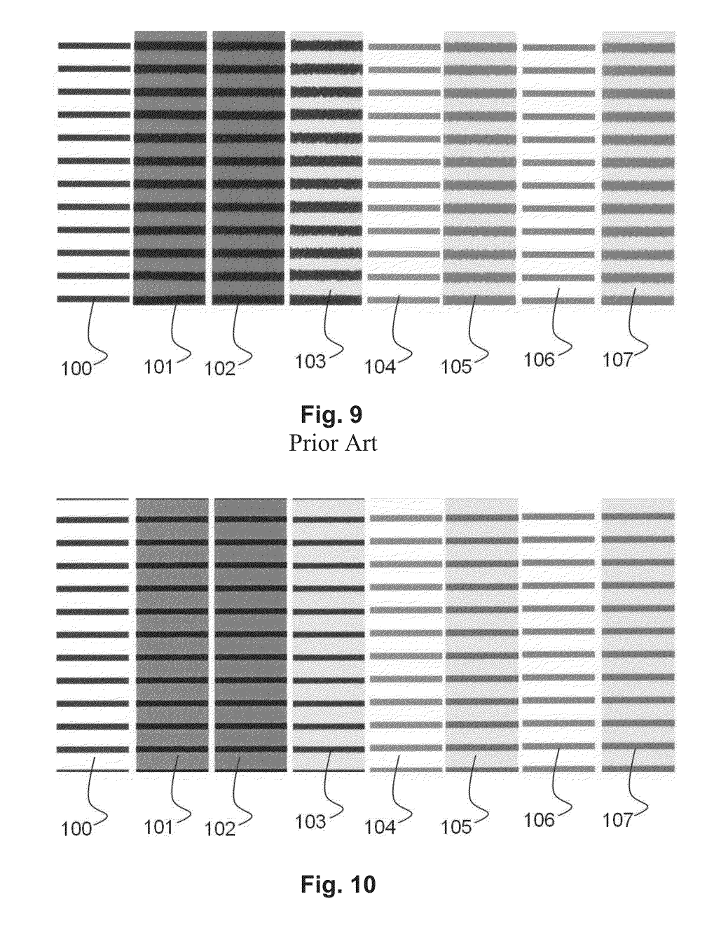

FIG. 9 shows a photograph of a test print from which the level of bleeding for a number of color combinations can be seen. Table 4 explains the color combinations of the parts 100-107 as indicated in FIG. 9.

Bleeding is clearly visible for most combinations of inks in the ink set according to this comparative example.

TABLE 4
Area and line color combinations of FIGS. 9, 10, 12 and 13

| Number of test | | |
|---|---|---|
| part in FIGS. 9 | Background | |
| and 10 | color (Area) | Line color |
| 100 | — | K |
| 101 | C | K |
| 102 | M | K |
| 103 | Y | K |
| 104 | — | C |
| 105 | Y | C |
| 106 | — | M |
| 107 | Y | M |

### Example 4

### Bleeding Performance of an Ink Set According to the Present Invention

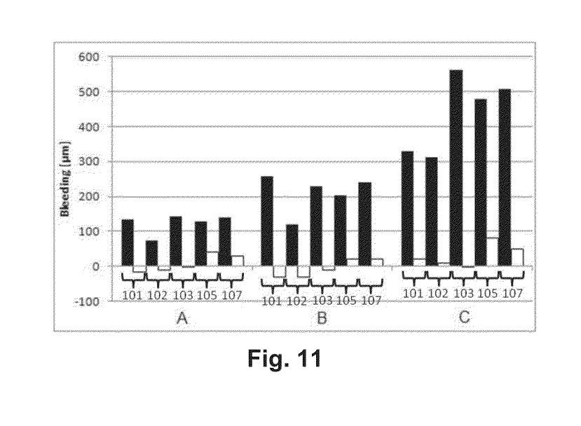

The K1 and Y1 inks as used in Comparative Example A were adapted as shown in Table 3A, where the K2 ink contains less ethoxylated siloxane surfactant (in the present example, Tegowet 240) and the Y2 ink contains more ethoxylated siloxane surfactant. The level of bleeding can visually be seen in FIG. 10. It can be seen that the bleeding performance for most color combinations has improved compared to the situation as shown in FIG. 9.

For comparison, bleeding levels for both Comparative Example A and Example 4 have been measured too, in accordance with the above described method and using ImageXpert software. The results are shown in FIG. 11. The capital letters on the x-axis of the graph in FIG. 11 represent the media types given in Table 1. On the y-axis, the difference between line widths printed and determined as indicated above is shown in micrometers. The numbers in the x-axis correspond to the color combinations given in Table 4.

It can be clearly seen that the level of bleeding of combinations of inks from an ink set according to the present example (white bars in FIG. 11) has improved tremendously in comparison to the level of bleeding of ink combinations of inks from an ink set not according to the present invention (black bars in FIG. 11). The combination with only Cyan ink and Magenta ink has not improved, but since nothing was changed there, that was also not to be expected.

### Example 5

### Bleeding Performance of an Ink Set According to the Present Invention

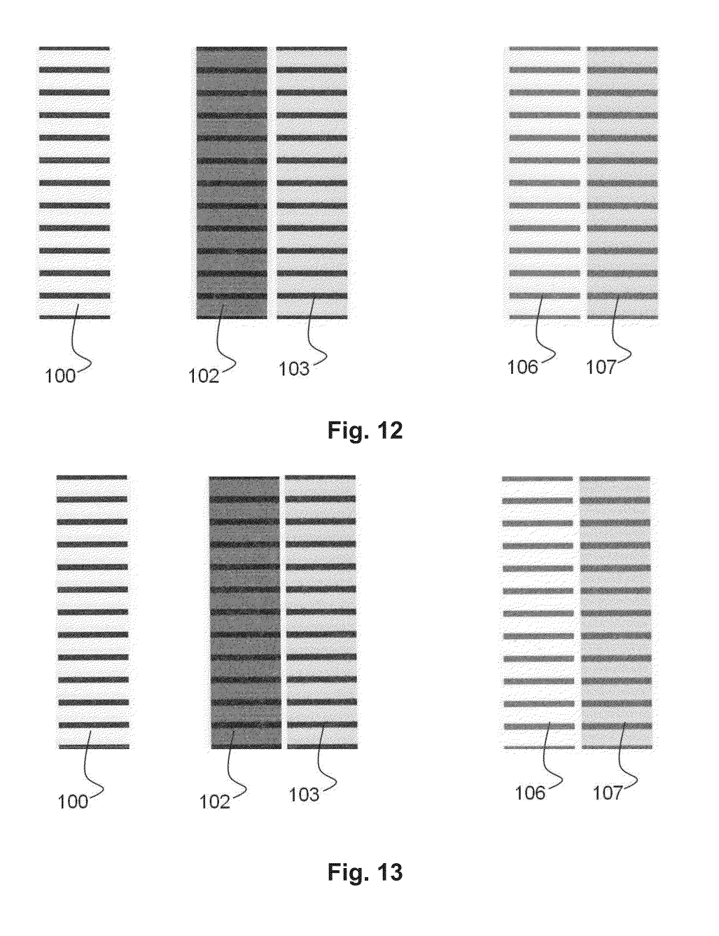

The K1 and Y1 inks as used in Comparative Example A were adapted as shown in Table 3B, where the K3 ink contains less ethoxylated siloxane surfactant (in the present example, Tegowet 240) and the Y3 ink contains more ethoxylated siloxane surfactant. The level of bleeding can visually be seen in FIG. 12. It can be seen that the bleeding performance for most color combinations has improved compared to the situation as shown in FIG. 9.

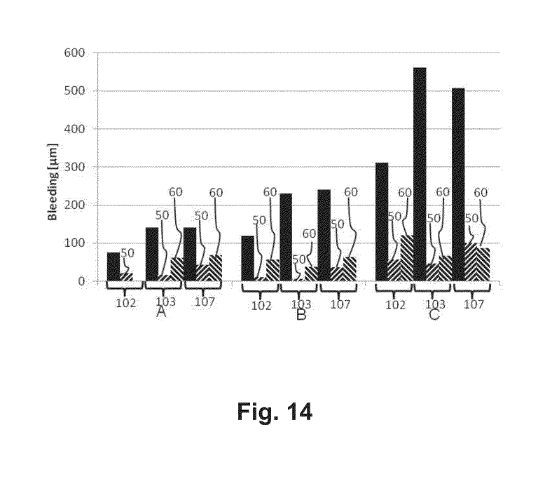

For comparison, bleeding levels for both Comparative Example A and Example 5 have been measured too, in accordance with the above described method and using ImageXpert software. The results are shown in FIG. 14. The capital letters on the x-axis of the graph in FIG. 14 represent the media types given in Table 1. On the y-axis, the difference between line widths printed and determined as indicated above is shown in micrometers. The numbers in the x-axis correspond to the color combinations given in Table 4.

It can be clearly seen that the level of bleeding of combinations of inks from an ink set according to the present example (shaded bars in FIG. 14 indicated with 50) has improved tremendously in comparison to the level of bleeding of ink combinations of inks from an ink set not according to the present invention (black bars in FIG. 14, which represents the ink combination K1, M and Y1).

The ink compositions in the ink set according to the present example have similar static and dynamic surface tensions (see Tables 3A and 3B).

### Example 6

### Bleeding Performance of an Ink Set According to the Present Invention

The K1, Y1 and M inks as used in Comparative Example A were adapted as shown in Table 3B, wherein another ethoxylated siloxane surfactant was used, i.e. Byk 348 instead of Tegowet 240. In the M′ ink, the Tegowet 240 was substituted by a same amount of Byk 348. The K4 ink contains less ethoxylated siloxane surfactant, and the Y4 ink contains more ethoxylated siloxane surfactant. The level of bleeding can visually be seen in FIG. 13. It can be seen that the bleeding performance for most color combinations has improved compared to the situation as shown in FIG. 9.

For comparison, bleeding levels for both Comparative Example A and Example 6 have been measured too, in accordance with the above described method and using ImageXpert software. The results are shown in FIG. 14. The capital letters on the x-axis of the graph in FIG. 14 represent the media types given in Table 1. On the y-axis, the difference between line widths printed and determined as indicated above is shown in micrometers. The numbers in the x-axis correspond to the color combinations given in Table 4.

It can be clearly seen that the level of bleeding of combinations of inks from an ink set according to the present example (shaded bars in FIG. 14 indicated with 60) has improved tremendously in comparison to the level of bleeding of ink combinations of inks from an ink set not according to the present invention (black bars in FIG. 14, which represents the ink combination K1, M and Y1).

In this example, all inks contained Byk 348 as surfactant in different concentrations. Byk 348 is like Tegowet 240, an ethoxylated siloxane surfactant. Therefore, the bleeding results are compared to the reference ink combination K1, M and Y1.

The ink compositions in the ink set according to the present example have similar static and dynamic surface tensions (see Tables 3A and 3B).

Considering Comparative Example A and Examples 4, 5 and 6 and regardless of the exact recipe of the aqueous ink, the bleeding level can be controlled with the amount of surfactant that (primarily) acts at the interface ink-ink and/or ink/media.

1. An ink set, comprising:
a first ink composition and
a second ink composition,
wherein the first and second ink compositions comprise a silicone surfactant, and
wherein the total concentration of silicone surfactants in the first and second ink compositions are different in order to control bleeding of the first and second ink compositions into each other.

2. The ink set according to claim 1, wherein the first ink composition has a lightness L₁* and the second ink composition has a lightness L₂*, the lightness being defined in accordance with the CIELAB color system, wherein L₂*<L₁*, wherein the first and second ink compositions comprise a silicone surfactant, wherein the total weight fraction of silicone surfactant in the first ink composition is larger than the total weight fraction of silicone surfactant in the second ink composition.

3. The ink set according to claim 2, wherein the ratio of the total weight fraction of silicone surfactant in the second ink composition and the total weight fraction of the silicone surfactant in the first ink composition is in a range of between 0 and 0.95.

4. The ink set according to claim 2, wherein the ink set comprises a third ink composition having a lightness L₃*, wherein L₃*<L₂*<L₁*, wherein the third ink composition comprises a silicone surfactant, wherein the total weight fraction of silicone surfactant in the second ink composition is larger than the total weight fraction of silicone surfactant in the third ink composition.

5. The ink set according to claim 4, wherein the third ink composition has the lowest lightness value of the ink set.

6. The ink set according to claim 5, wherein the third ink composition is a black ink composition.

7. The ink set according to claim 4, wherein the first ink composition has the highest lightness value of the ink set.

8. The ink set according to claim 7, wherein the first ink composition is a yellow ink composition.

9. The ink set according to claim 2, wherein the second ink composition is a cyan and/or magenta ink composition.

10. The ink set according to claim 1, wherein the silicone surfactant is one or more siloxane surfactants.

11. The ink set according to claim 10, wherein the silicone surfactant has a structure according to Formula 2: 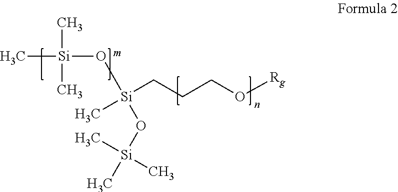
wherein m is an integer ranging from 1-25, and wherein n is an integer ranging from 1-10, and wherein Rg is an endgroup which is selected from the group consisting of —H and alkyl.

12. The ink set according to claim 1, wherein the silicone surfactant in each ink composition is present in an amount of between 0 and 1.5 wt % relative to the total ink compositions.

13. The ink set according to claim 1, wherein each ink composition further comprises an acetylene glycol surfactant in an amount of between 0.5 and 2 wt % relative to the total ink composition.

14. The ink set according to claim 13, wherein each ink composition contains an equal amount of acetylene glycol surfactant.

15. The ink set according to claim 1, comprising a black, cyan, magenta and yellow pigmented aqueous ink composition, wherein each composition comprises an ethoxylated acetylene surfactant in an equal amount of between 0.5 and 2 wt % relative to the total ink composition and wherein the ink compositions further comprise an ethoxylated siloxane surfactant in an amount of between 0 and 1 wt %, wherein the amount of siloxane surfactant in the yellow ink composition is the highest compared to the other ink compositions and wherein the amount of siloxane surfactant in the black ink is the lowest compared to the other ink compositions.

16. The ink set according to claim 2, wherein the ratio of the total weight fraction of silicone surfactant in the second ink composition and the total weight fraction of the silicone surfactant in the first ink composition is in a range of between 0.5 and 0.9.

17. The ink set according to claim 2, wherein the ratio of the total weight fraction of silicone surfactant in the second ink composition and the total weight fraction of the silicone surfactant in the first ink composition is in a range of between 0.7 and 0.8.

18. The ink set according to claim 1, wherein the silicone surfactant is one or more ethoxylated siloxane surfactants.

19. The ink set according to claim 1, wherein each ink composition further comprises an ethoxylated acetylene glycol surfactant in an amount of between 0.5 and 2 wt % relative to the total ink composition.
